(19) United States
(12) Patent Application Publication
(10) Pub. No.: US 2024/0076160 A1
(43) Pub. Date: Mar. 7, 2024

(54) ELEVATOR SYSTEM AND A METHOD FOR SELECTING A WIRELESS COMMUNICATION SYSTEM

(71) Applicant: KONE Corporation, Helsinki (FI)

(72) Inventor: Mikko PURANEN, Helsinki (FI)

(73) Assignee: KONE Corporation, Helsinki (FI)

(21) Appl. No.: 18/389,254

(22) Filed: Nov. 14, 2023

Related U.S. Application Data
(63) Continuation of application No. PCT/EP2021/064629, filed on Jun. 1, 2021.

(51) Int. Cl. B66B 1/34

(52) U.S. Cl. CPC B66B 1/3453; B66B 1/3461

(57) ABSTRACT

An elevator system selects a wireless communication system. The elevator system includes: an elevator car, a car control unit, and an elevator control unit. The car control unit and the elevator control unit establishes at least two wireless communication systems for providing wireless communication between the elevator control unit and the car control unit. The elevator control unit is configured to obtain selection data representing at least one selection parameter. The at least one selection parameter includes at least one elevator related selection parameter and/or at least one wireless communication system related selection parameter. The elevator control unit selects based on the obtained selection data the most appropriate wireless communication system at each point of time to be used to provide the wireless communication connection between the elevator control unit and the car control unit.

### TECHNICAL FIELD

The invention concerns in general the technical field of elevator systems. Especially the invention concerns elevator systems with wireless communication.

### BACKGROUND

An elevator system comprises at least one elevator car arranged to travel along a respective at least one elevator shaft and an elevator control unit for controlling operations of the elevator system. Typically, a travelling cable is used to connect electrical devices of the at least one elevator car to the elevator control unit.

Typically, in the elevator systems, especially in high-rise elevator systems, the travelling cable is a costly component, an installation of the travelling cable is time-consuming, a cable drum may be difficult to handle due to its size and weight, and the travelling cable may get easily damaged, which in turn leads to a costly replacement of the travelling cable and unnecessary downtime of the elevator system.

The travelling cable may be replaced with a wireless communication system to connect the electrical devices of the at least one elevator car to the elevator control unit by using a wireless communication technology. However, an implementation of a reliable wireless communication system that meets strict requirements set by, for example safety regulations, may be difficult.

The reliability of the wireless communication system may be reduced because of several reasons, e.g. communication distance, interferences in the communication system, and/or sway of a suspension device of the elevator car blocking a line of sight. Typically, the communication connection is lost only temporarily, but since an elevator safety system requires continuous communication, even a short break in the communication leads to an elevator emergency stop.

Thus, there is a need to develop solutions in order to improve at least partly reliability of wireless communication of an elevator system.

### SUMMARY

The following presents a simplified summary in order to provide basic under-standing of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present an elevator system, a method, and a computer program for selecting a wireless communication system. Another objective of the invention is that the method, and a computer program for selecting a wireless communication system improve at least partly reliability of wireless communication of an elevator system.

The objectives of the invention are reached by an elevator unit, a method, and a computer program as defined by the respective independent claims.

According to a first aspect, an elevator system for selecting a wireless communication system is provided, wherein the elevator system comprises: an elevator car arranged to travel along an elevator shaft, a car control unit arranged to the elevator car, and an elevator control unit, wherein the car control unit and the elevator control unit comprise communication means to establish at least two wireless communication systems for providing wireless communication between the elevator control unit and the car control unit, and wherein the elevator control unit is configured to: obtain selection data representing at least one selection parameter, wherein the at least one selection parameter comprises at least one elevator related selection parameter and/or at least one wireless communication system related selection parameter; and select based on the obtained selection data the most appropriate wireless communication system from amongst the at least two wireless communication systems at each point of time to be used to provide the wireless communication connection between the elevator control unit and the car control unit.

The elevator control unit may further be configured to select another wireless communication system from amongst the at least two wireless communication systems to be used to provide the wireless communication connection between the elevator control unit and the car control unit, in response to that the elevator control unit detects based on the obtained selection data that said another wireless communication system is the most appropriate at a later point of time.

The at least one selection parameter may be predefined or defined dynamically on a need-basis.

Alternatively or in addition, the at least one elevator related selection parameter may comprise at least one of the following: a location of the elevator car inside the elevator shaft, a speed of the elevator car, and/or a sway of a suspension device of the elevator car.

Alternatively or in addition, the at least one wireless communication system related selection parameter may comprise detected interference in the wireless communication system.

The at least two wireless communication systems may differ from each other by at least one of a frequency band, a modulation technique, a power level, an antenna type, and/or antenna properties.

Alternatively or in addition, the at least two wireless communication systems may differ from each other by a communication technology.

The different communication technologies of the at least two wireless communication systems may comprise at least two of the following communication technologies: a point-to-point microwave link, 5G, a free space optical communication technology, Bluetooth (BT), Zigbee, so that each wireless communication system is based on a different communication technology than the other wireless communication systems.

According to a second aspect, a method for selecting a wireless communication system for providing wireless communication connection between an elevator control unit and a car control unit arranged to an elevator car is provided, wherein the car control unit and the elevator control unit comprise communication means to establish at least two wireless communication systems for providing wireless communication connection between the elevator control unit and the car control unit, wherein the method comprises: obtaining, by the elevator control unit, selection data representing at least one selection parameter, wherein the at least one selection parameter comprises at least one elevator related selection parameter and/or at least one wireless communication system related selection parameter; selecting, by the elevator control unit, based on the obtained selection data the most appropriate wireless communication system from amongst the at least two wireless communication systems at each point of time to be used to provide the wireless communication connection between the elevator control unit and the car control unit.

The method may further comprise selecting another wireless communication system from amongst the at least two wireless communication systems to be used to provide the wireless communication connection between the elevator control unit and the car control unit, in response to detecting based on the selection data that said another wireless communication system is the most appropriate at a later point of time.

The at least one selection parameter may be predefined or defined dynamically on a need-basis.

Alternatively or in addition, the at least one elevator related selection parameter may comprise at least one of a location of the elevator car inside the elevator shaft, a speed of the elevator car, and/or a sway of a suspension device of the elevator car.

Alternatively or in addition, the at least one wireless communication system related selection parameter may comprise detected interference in the wireless communication system.
the at least two wireless communication systems may differ from each other by at least one of a frequency band, a modulation technique, a power level, an antenna type, and/or antenna properties.

Alternatively or in addition, the at least two wireless communication systems may differ from each other by a communication technology.

The different communication technologies of the at least two wireless communication systems may comprise at least two of the following communication technologies: a point-to-point microwave link, 5G, a free space optical communication technology, Bluetooth (BT), or Zigbee, so that each wireless communication system is based on a different communication technology than the other wireless communication systems.

According to a third aspect, a computer program is provided, wherein the computer program comprises instructions which, when the program is executed by an elevator control unit, cause the elevator control unit to carry out the method as described above.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1A illustrates schematically an example of an elevator system.

FIG. 1B illustrates schematically another example of the elevator system.

FIG. 2 illustrates an example of at least two wireless communication systems.

FIG. 3 illustrates an example of a method for selecting a wireless communication system.

FIG. 4 illustrates schematically an example of components of an elevator control unit.

FIG. 5 illustrates schematically an example of components of a car control unit.

### DESCRIPTION OF THE EXEMPLIFYING EMBODIMENTS

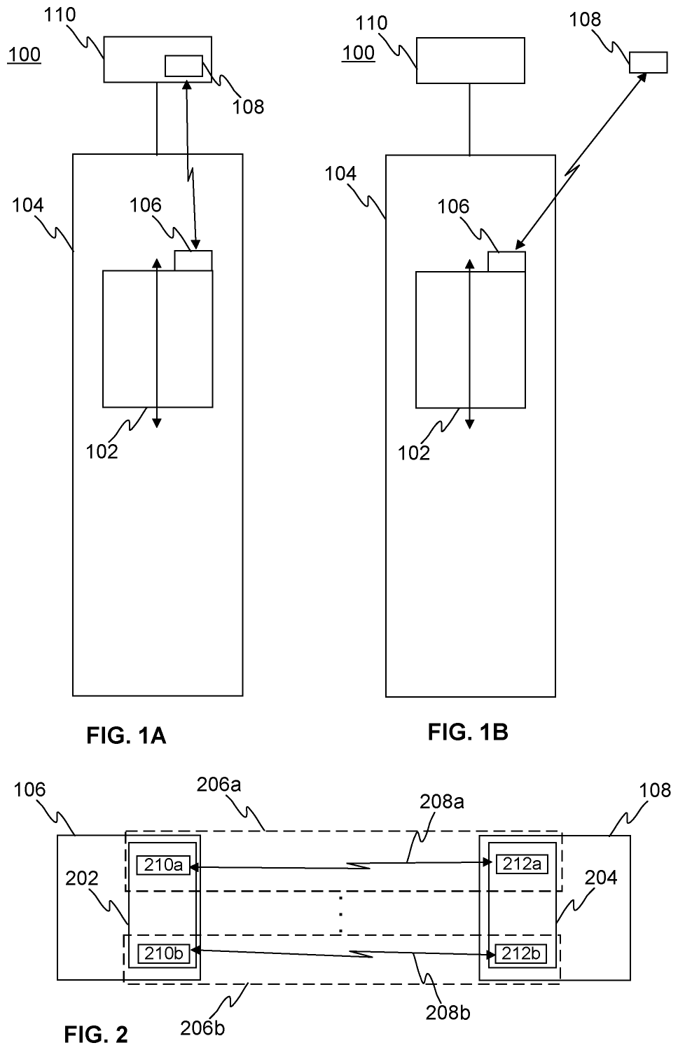

FIG. 1A illustrates schematically an example of an elevator system 100 for selecting a wireless communication system. The elevator system 100 comprises an elevator car 102 arranged to travel along an elevator shaft 104 between a plurality of landings, a car control unit 106, and an elevator control unit 108. The car control unit 106 is arranged to the elevator car 102, e.g. to a rooftop of the elevator car 102 as illustrated in the example of FIG. 1A. The elevator system 100 of the example of FIG. 1A comprises one elevator car 102 travelling along one elevator shaft 104, however the elevator system 100 may also comprise an elevator group, i.e. group of two or more elevator cars 102 each travelling along a separate elevator shaft 104 configured to operate as a unit serving the same landings (for sake of clarity the plurality of landings are not illustrated in FIG. 1A). The elevator system 100 further comprises an elevator control system 110, e.g. an elevator controller, 110. The elevator control system 110 may be configured to control the operation of the elevator system 100 at least in part. The elevator control system 110 may reside e.g. in a machine room (for sake of clarity not shown in FIG. 1A) or in one of the landings of the elevator system 100.

The elevator system 100 may further comprise one or more other known elevator related entities, e.g. hoisting system, user interface devices, safety circuit and devices, elevator door system, etc., which are not shown in FIG. 1A for sake of clarity.

The elevator control unit 108 may be a local elevator control unit, i.e. the elevator control unit 108 may be located on-site, i.e. at the elevator system 100. The local elevator control unit 108 may be implemented as a part of the elevator control system 110 as in the example elevator system 100 of FIG. 1A. The elevator control unit 108 implemented as the part of the elevator control system 110 may be configured to control one or more operations or functionalities of the elevator system 100. The one or more operations or functionalities of the elevator system 100, which the elevator control unit 108 may be configured to control, may for example comprise, but is not limited to, one or more hoisting related operations or functionalities, one or more lighting related operations or functionalities, etc. Alternatively or in addition, the elevator control unit 108 may be an external control unit, i.e. the elevator control unit 108 may locate off-site, i.e. external to the elevator system 100. The external elevator control unit may be implemented as an external entity to the elevator system 108 as illustrated in FIG. 1B. FIG. 1B illustrates schematically an example of the elevator system 100 in which the elevator control unit 108 is the external elevator control unit. The example elevator system 100 of FIG. 1B is otherwise similar to the example elevator system 100 of FIG. 1A described above. In other words, the example elevator system 100 of FIG. 1B may comprise otherwise the same entities as the example elevator system 100 of FIG. 1A described above. The external elevator control unit may be e.g. a cloud server, a service center, or a data center.

FIG. 2 illustrates an example of at least two wireless communication systems 206a, 206b established for providing a wireless communication connection 206a, 206b, between the elevator control unit 108 and the car control unit 106. The car control unit 106 and the elevator control unit 108 comprise communication means 202, 204 to establish at least two wireless communication systems 206a, 206b for providing the wireless communication connection 208a, 208b, between the elevator control unit 108 and the car control unit 106. In other words, the car control unit 106 comprises communication means 202 and the elevator control unit 108 comprises communication means 204, which together are configured to establish the at least two wireless communication systems 206a, 206b for providing the wireless communication connection 206a, 206b, between the elevator control unit 108 and the car control unit 106. The communication means 202 of the car control unit 106 may comprise one or more communication devices 210a, 210b, e.g. at least one radio transceiver, at least one antenna, etc., for each of the at least two wireless communication systems 206a, 206b. Similarly, the communication means 204 of the elevator control unit 108 may comprise corresponding one or more communication devices 212a, 212b for each of the at least two wireless communication systems 206a, 206b. The one or more communication devices 210a, 210b, 212a, 212b may depend on a communication technology used for each wireless communication system 206a, 206b. In the example of FIG. 2 two wireless communication systems 206a, 206b, e.g. a first wireless communication system 206a and a second wireless communication system 206b, are illustrated, but the three dots in FIG. 2 depict that there may also be established more than two wireless communication systems 206a, 206b. The wireless communication connection 208a, 208b, between the elevator control unit 108 and the car control unit 106 enables data exchange, i.e. communication, between the elevator control unit 108 and the car control unit 106. In other words, the elevator control unit 108 may provide data to the car control unit 106 via the wireless communication connection 208a, 208b and/or the car control unit 106 may provide data to the elevator control unit 108 via the wireless communication connection 208a, 208b. The data may comprise any data regarding to the elevator system 100. The data regarding to the elevator system 100 may comprise for example, but not limited to, movement data of the elevator car 104, any safety related data, and/or control data, etc.

The at least two wireless communication systems 206a, 206b may differ from each other by a communication technology. In other words, each wireless communication system 206a, 206b of the at least two wireless communication systems 206a, 206b may be based on a different communication technology than the other wireless communication systems 206a, 206b. For example, in case of two wireless communication systems 206a, 206b, the first wireless communication system 206a may be based on a first communication technology and the second wireless communication system 206b may be based on a second communication technology. The different communication technologies of the at least two wireless communication systems 206a, 206b may comprise at least two of the following communication technologies: a point-to-point microwave link, 5G, a free space optical communication technology, Bluetooth (BT), Zigbee, so that each wireless communication system 206a, 206b is based on a different communication technology than the other wireless communication systems 206a, 206b. According to a non-limiting example, in case of two communication systems 206a, 206b, the first wireless communication system 206a may be based e.g. on 5G and the second wireless communication system 206b may be based on e.g. the point-to-point microwave link.

Alternatively or in addition, the at least two wireless communication systems 206a, 206b may differ from each other by at least one of the following: a frequency band, a modulation technique, a power level, an antenna type, and/or antenna properties. According to an example, all the at least two wireless communication systems 206a, 206b may be based on the same communication technology, but differ from each other by at least one of the following: a frequency band, a modulation technique, a power level, an antenna type, and/or antenna properties. According to another example, each of the at least two communication systems 206a, 206b may be based on different communication technologies and further differ from each other by at least one of a frequency band, a modulation technique, a power level, an antenna type, and antenna properties.

According to a non-limiting example, in case of two communication systems 206a, 206b, both communication systems 206a, 206b may be based e.g. on the point-to-point microwave link, but the first wireless communication system 206a may use e.g. different modulation technique, different power level and/or have different antenna type, than the second wireless communication system 206b.

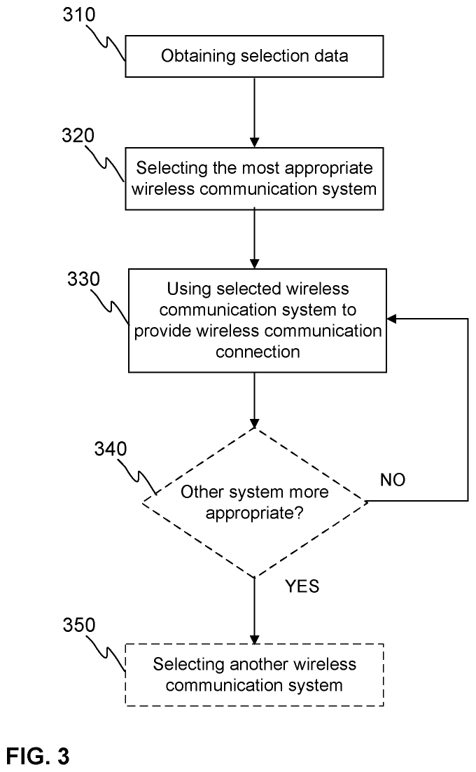

FIG. 3 illustrates an example of a method for selecting the wireless communication system 206a, 206b for providing the wireless communication connection 208a, 208b between the elevator control unit 108 and the car control unit 106. At an initial starting situation, one of the at least two wireless communication systems 206a, 206b may be used to provide the wireless communication connection 208a, 208b between the elevator control unit 108 and the car control unit 106.

At the step 310, the elevator control unit 108 obtains selection data representing at least one selection parameter. The at least one selection parameter comprises at least one elevator related selection parameter and/or at least one wireless communication system related selection parameter. The elevator control unit 108 may obtain the selection data continuously. The continuous obtaining the selection data enables that the elevator control unit 108 is continuously able to respond to one or more changes detected in the obtained selection data, which in turn enables that the elevator control unit 108 may continuously select the most appropriate wireless communication system 206a, 206b for providing the wireless communication connection 208a, 208b between the elevator control unit 108 and the car control unit 106 as will be described. The at least one elevator related selection parameter may comprise at least one of the following: a location of the elevator car inside the elevator shaft, a speed of the elevator car, and/or a sway of a suspension device of the elevator car 102. The sway of the suspension device, e.g. a rope or a belt, may block a line of sight of the wireless communication connection 208a, 208b. The at least one wireless communication system related selection parameter may comprise detected interference in the wireless communication system 206a, 206b. The elevator control unit 108 may obtain the selection data representing the at least one elevator related selection parameter for example from the elevator system 100 and/or from one or more sensor devices arranged to the elevator system 100 and configured to provide the sensor data. The elevator control unit 108 may obtain the selection data representing the at least one wireless communication system related selection parameter for example by characterizing and/or monitoring network traffic in the at least two wireless communication systems 206a, 206b.

At the step 320, the elevator control unit 108 selects based on the obtained selection data the most appropriate wireless communication system 206a, 206b from amongst the at least two wireless communication systems 206a, 206b at each point of time to be used to provide the wireless communication connection 208a, 208b between the elevator control unit 108 and the car control unit 106 at a step 330. In other words, the elevator control unit 108 selects based on the obtained selection data the most appropriate wireless communication system 206a, 206b from amongst the at least two wireless communication systems 206a, 206b at each point of time, i.e. at each point of time when the selection is performed. This enables that the most appropriate wireless communication system 206a, 206b at each point of time may be selected substantially in real-time. Alternatively or in addition, this enables that a reliable wireless communication connection 208a, 208b between the elevator control unit 108 and the car control unit 106 may be constantly provided. For example, at a certain point of time depending on the at least one selection parameter, one of the at least two wireless communication systems 206a, 206b may be the most appropriate, i.e. more appropriate than the other wireless communication systems 206a, 206b, and at any other point of time some other wireless communication system 206a, 206b may be the most appropriate. The at least one selection parameter and/or a change of the at least one selection parameter, may affect the wireless communication connection 208a, 208b of each wireless communication system 206a, 206b in different ways. In other words, depending on the selection parameter and the point of time at least one of the at least two wireless communication systems 206a, 206b may be the most appropriate wireless communication system. With the term “most appropriate wireless communication system” is meant throughout this application a wireless communication system 206a, 206b having the most appropriate one or more operating parameters for the wireless communication connection 208a, 208b between the elevator control unit 108 and the car control unit 106. The one or more operating parameters may for example comprise, but are not limited to, signal strength, signal quality, capability to transfer required amount of data, and/or capability to transfer required type of data. In other words, the most appropriate wireless communication system 206a, 206b at a certain point of time may have for example, but not limited to, the most appropriate signal strength, signal quality, capability to transfer required amount of data (e.g. large amount of data), and/or capability to transfer required type of data, at said certain point of time. Depending on the operating parameter, the most appropriate may be for example the highest, the best, and/or the largest, etc. For example, some of the at least two wireless communication systems 208a, 208b may be more appropriate, i.e. more suitable, for short range wireless communication and some other of the at least two wireless communication systems 208a, 208b may be more tolerant against interferences. The reliability of each wireless communication system 206a, 206b may vary (e.g. be reduced or improved) depending on the at least one selection parameter and/or on a change of the at least one selection parameter. According to an example, change in a communication distance, i.e. in the location of the elevator car 102 inside the elevator shaft 104, may reduce the reliability of one or more of the at least two wireless communication systems 206a, 206b, and improve the reliability of other one or more of the at least two wireless communication systems 206a, 206b. According to another example, interferences may reduce reliability of one or more of the at least two wireless communication systems 206a, 206b. According to yet another example, the sway of the suspension device of the elevator car 104 may reduce the reliability of one or more of the at least two wireless communication systems 206a, 206b. The elevator control unit 108 may obtain the one or more operating parameters for example by characterizing and/or monitoring network traffic in the at least two wireless communication systems 206a, 206b.

According to an example, when the car control unit 106 and the elevator car control unit 108 are substantially close to each other, e.g. when the elevator car 102 locates e.g. close to a top of the elevator shaft 104 and the elevator control unit 108 locates e.g. inside the machine room that locates at the top of the elevator shaft 104, the most appropriate wireless communication system 206a, 206b may be a wireless communication system using lower power level and/or less directional antenna. According to another example, when the car control unit 106 and the elevator car control unit 108 are far away from each other, e.g. when the elevator car 102 locates e.g. close to a pit of the elevator shaft 104 and the elevator control unit 108 locates e.g. inside the machine room that locates at the top of the elevator shaft 104, the most appropriate wireless communication system 206a, 206b may be a wireless communication system using higher power level, and/or more directional antenna. In these examples, the at least one selection parameter comprises at least the location of the elevator car 102 inside the elevator shaft 104. The location of the elevator car 102 inside the elevator shaft 104 effects on the communication distance between the elevator control unit 108 and the elevator car control unit 106.

According to another example, when sway of the suspension device of the elevator car 102 is detected to block the line of sight, the most appropriate wireless communication system 206a, 206b may be a wireless communication system that operates without the line of sight. In this example, the at least one selection parameter comprises at least the sway of the suspension device of the elevator car 102.

According to another example, when interference (e.g. radio frequency interference (RFI)) is detected in the wireless communication system 206a, 206b currently used, the most appropriate wireless communication system 206a, 106b may be a wireless communication system which uses frequency hopping. In this example, the at least one selection parameter comprises at least detected interference in the wireless communication system.

According to an example, the most appropriate wireless communication system 206a, 206b for at least one of the at least one selection parameter or for each of the at least one selection parameter may be predefined. In other words, the elevator control unit 108 may predefine a certain wireless communication system 206a, 206b to be the most appropriate for at least one of the at least one selection parameter or for each of the at least one selection parameter. This means that the at least one selection parameter may be predefined, i.e. the selection may be based on at least one predefined selection parameter. The elevator control unit 108 may for example use for the predefinition historical data of the selection data and/or the one or more operating parameters of the at least two wireless communication systems 206a, 206b; statical data of the selection data and/or the one or more operating parameters of the at least two wireless communication systems 206a, 206b, and/or data learned by using e.g. machine learning algorithms. According to an example, if the at least one selection parameter is the location of the elevator car 102 inside the elevator shaft 104, the elevator control unit 108 may predefine that a certain wireless communication system 206a, 206b is used when the elevator car 102 locates at certain predefined location inside the elevator shaft 104. For example, the elevator control unit 108 may predefine that the first wireless communication system 206a may be selected, when the elevator car 102 locates at the top floor. Alternatively, the most appropriate wireless communication system for at least one of the at least one selection parameter or for each of the at least one selection parameter may be defined dynamically on a need-basis. In other words, the elevator control unit 108 may dynamically on the need-basis define the most appropriate wireless communication system 206a, 206b for at least one of the at least one selection parameter or for each of the at least one selection parameter. This means that the at least one selection parameter may be defined dynamically on a need-basis, i.e. the selection may be based on at least one dynamically defined selection parameter.

According to an example, alternatively or in addition, the one or more selection parameters may be prioritized for the selection of the most appropriate wireless communication system 206a, 206b. The elevator control unit 108 may select the most appropriate wireless communication system 206a, 206b based on the one or more selection parameters having highest priority. In other words, one or more of the selection parameters may have a higher importance in the selection of the most appropriate wireless communication system 206a, 206b at the step 320.

As discussed above, at the step 330, i.e. after selecting the most appropriate wireless communication system 206a, 206b at the step 320 and during the use of the selected wireless communication system 206a, 206b for providing the wires communication connection 208a, 208b between the elevator control unit 108 and the car control unit 106, the elevator control unit 108 may continue obtaining the selection data.

According to an example, if the obtained selection data indicates that another wireless communication system 206a, 206b is the most appropriate at a later point of time, i.e. the elevator control unit 108 detects at a step 340 based on the obtained selection data that another wireless communication system 206a, 206b is the most appropriate at a later point of time, the elevator control unit 108 may select at a step 350 said another wireless communication system 206a, 206b from amongst the at least two wireless communication systems 206a, 206b to be used to provide the wireless communication connection 208a, 208b between the elevator control unit 108 and the car control unit 106. These steps are illustrated as the optional steps 340 and 350 in the example of FIG. 3. Alternatively, if the obtained selection data indicates that the previously selected wireless communication system 206a, 206b, i.e. the wireless communication system 206a, 206b currently used to provide the wireless communication connection 208a, 208b between the elevator control unit 108 and the car control unit 106, is still the most appropriate at said later point of time, the use of the previously selected wireless communication system 206a, 206b is continued for providing the wireless communication connection 208a, 208b between the elevator control unit 108 and the car control unit 106, and the elevator control unit 108 continues to obtain the selection data.

Next an example for selecting the wireless communication system 206a, 206b by using two wireless communication systems 206a, 206b, e.g. illustrated in FIG. 2, i.e. the first wireless communication system 206a and the second wireless communication system 206b. In this non-limiting example, the at least one selection parameter is the location of the elevator car 102 inside the elevator shaft 104 and the most appropriate one or more operating parameters for the wireless communication connection 208a, 208b between the elevator control unit 108 and the car control unit 106 is the highest signal quality. However, the invention is not limited to these and any other at least one selection parameter and/or one or more operating parameters may be used. As an initial assumption, the first wireless communication system 206a is used to provide the wireless communication connection 208a between the elevator control unit 108 and the car control unit 106 at a starting situation, for example because at the starting situation, the first wireless communication system 206a has the highest signal strength. However, also the second communication system 206b could be used to provide the wireless communication connection 208b between the elevator control unit 108 and the car control unit 106 at the starting situation. The elevator control unit 108 obtains continuously the selection data representing, in this example, the location of the elevator car 102 inside the elevator shaft 104, when the elevator car 102 is moving along the elevator shaft 102, e.g. from the top floor to the bottom floor, and at a certain point of time, the elevator control unit 108 detects based on the obtained selection data that the location of the elevator car 102 is such that the second wireless communication system 206b has the highest signal strength. In other words, the elevator control unit 108 detects that the second wireless communication system 108 is the most appropriate communication system based on the obtained selection data at said certain point of time. In response to the detection that the second wireless communication system 206b is the most appropriate wireless communication system, the elevator control unit 108 selects the second wireless communication system 206b to be used to provide the wireless communication connection 208b between the elevator control unit 108 and the car control unit 106. The second wireless communication system 206b is used to provide the wireless communication connection 208b between the elevator control unit 108 and the car control unit 106 after the selection and the elevator control unit 108 may continue obtaining the selection data.

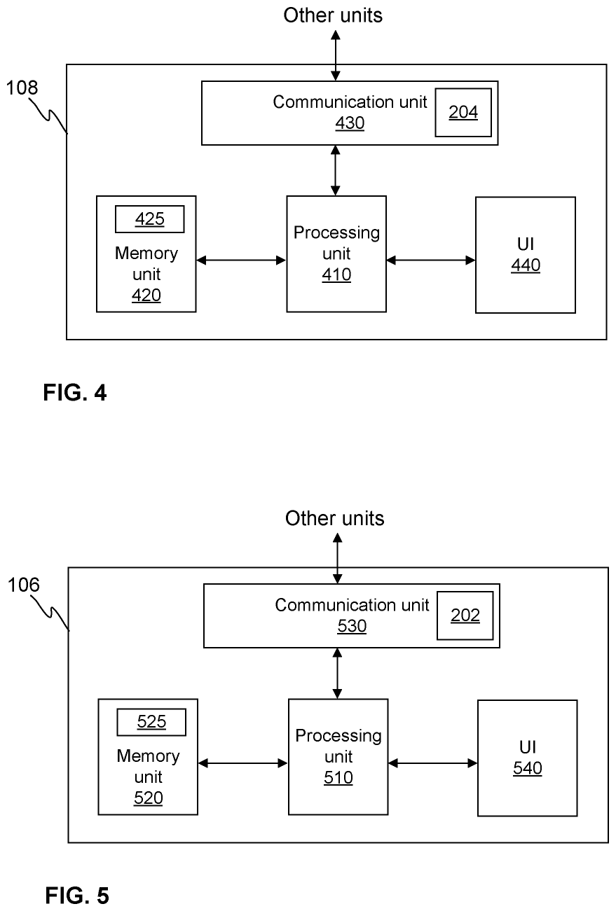

FIG. 4 schematically illustrates an example of components of the elevator control unit 108. The elevator control unit 108 may comprise a processing unit 410 comprising one or more processors, a memory unit 420 comprising one or more memories, a communication interface unit 430, and possibly a user interface (UI) unit 440. The mentioned elements may be communicatively coupled to each other with e.g. an internal bus. The memory unit 420 may store and maintain portions of a computer program (code) 425 and any other data, e.g. the obtained selection data. The computer program 425 may comprise instructions which, when the computer program 425 is executed by the processing unit 410 of the elevator control unit 108 may cause the processing unit 410, and thus the elevator control unit 108 to carry out desired tasks, e.g. at least some of the method steps described above. The processing unit 410 may thus be arranged to access the memory unit 420 and retrieve and store any information therefrom and thereto. For sake of clarity, the processor herein refers to any unit suitable for processing information and control the operation of the elevator control unit 108, among other tasks. The operations may also be implemented with a microcontroller solution with embedded software. Similarly, the memory unit 420 is not limited to a certain type of memory only, but any memory type suitable for storing the described pieces of information may be applied in the context of the present invention. The communication interface unit 430 provides an interface for communication with any external unit, e.g. the car control unit 106, one or more databases, and/or any other external unit. The communication interface unit 430 may comprise the above-described communication means 204 of the elevator control unit 108. The communication means 204 of the elevator control unit 108 may comprise one or more communication devices 210a, 210b, e.g. at least one radio transceiver, at least one antenna, etc., for each of the at least two wireless communication systems 206a, 206b as described above. The communication interface unit 430 may further comprise one or more other communication devices, for communication with any other units than the car control unit 106. The one or more user interface units 440 may comprise one or more input/output (I/O) devices, such as buttons, keyboard, touch screen, microphone, loud-speaker, display and so on, for receiving user input and outputting information. The computer program 425 may be a computer program product that may be comprised in a tangible non-volatile (non-transitory) computer-readable medium bearing the computer program code 425 embodied therein for use with a computer, i.e. the elevator control unit 108.

FIG. 5 schematically illustrates an example of components of the car control unit 106. The car control unit 106 may comprise a processing unit 510 comprising one or more processors, a memory unit 520 comprising one or more memories, a communication interface unit 530, and possibly a user interface (UI) unit 540. The mentioned elements may be communicatively coupled to each other with e.g. an internal bus. The memory unit 520 may store and maintain portions of a computer program (code) 525 and any other data, e.g. the obtained selection data. The computer program 525 may comprise instructions which, when the computer program 525 is executed by the processing unit 510 of the car control unit 106 may cause the processing unit 510, and thus the car control unit 106 to carry out desired tasks, e.g. at least some of the operations of the car control unit 106 as described above. The processing unit 510 may thus be arranged to access the memory unit 520 and retrieve and store any information therefrom and thereto. For sake of clarity, the processor herein refers to any unit suitable for processing information and control the operation of the car control unit 106, among other tasks. The operations may also be implemented with a microcontroller solution with embedded software. Similarly, the memory unit 520 is not limited to a certain type of memory only, but any memory type suitable for storing the described pieces of information may be applied in the context of the present invention. The communication interface unit 530 provides an interface for communication with any external unit, e.g. the elevator control unit 108, one or more databases, and/or any other external unit. The communication interface unit 530 may comprise the above-described communication means 202 of the car control unit 106. The communication means 202 of the car control unit 106 may comprise one or more communication devices 212a, 212b, e.g. at least one radio transceiver, at least one antenna, etc., for each of the at least two wireless communication systems 206a, 206b as described above. The communication interface unit 530 may further comprise one or more other communication devices, for communication with any other units than the elevator control unit 108. The one or more user interface units 540 may comprise one or more input/output (I/O) devices, such as buttons, keyboard, touch screen, microphone, loud-speaker, display and so on, for receiving user input and outputting information. The computer program 525 may be a computer program product that may be comprised in a tangible non-volatile (non-transitory) computer-readable medium bearing the computer program code 525 embodied therein for use with a computer, i.e. the car control unit 106.

The elevator system 100 and the method as described above improve the reliability of the wireless communication connection of the elevator system 100. The elevator system 100 and the method as described above reduce temporary breaks in the wireless communication connection, and thus also emergency stops of the elevator system may be reduced.

The specific examples provided in the description given above should not be construed as limiting the applicability and/or the interpretation of the appended claims. Lists and groups of examples provided in the description given above are not exhaustive unless otherwise explicitly stated.

1. An elevator system for selecting a wireless communication system, wherein the elevator system comprises:
an elevator car arranged to travel along an elevator shaft,
a car control unit arranged to the elevator car, and
an elevator control unit,
wherein the car control unit and the elevator control unit comprise communication means to establish at least two wireless communication systems for providing wireless communication between the elevator control unit and the car control unit, and
wherein the elevator control unit is configured to:
obtain selection data representing at least one selection parameter, wherein the at least one selection parameter comprises at least one elevator related selection parameter and/or at least one wireless communication system related selection parameter, and
select based on the obtained selection data the most appropriate wireless communication system from amongst the at least two wireless communication systems at each point of time to be used to provide the wireless communication connection between the elevator control unit and the car control unit.

2. The elevator system according to claim 1, wherein the elevator control unit is further configured to select another wireless communication system from amongst the at least two wireless communication systems to be used to provide the wireless communication connection between the elevator control unit and the car control unit, in response to that the elevator control unit detects based on the obtained selection data that said another wireless communication system is the most appropriate at a later point of time.

3. The elevator system according to claim 1, wherein the at least one selection parameter is predefined or defined dynamically on a need-basis.

4. The elevator system according to claim 1, wherein the at least one elevator related selection parameter comprises at least one of the following: a location of the elevator car inside the elevator shaft, a speed of the elevator car, and/or a sway of a suspension device of the elevator car.

5. The elevator system according to claim 1, wherein the at least one wireless communication system related selection parameter comprises detected interference in the wireless communication system.

6. The elevator system according to claim 1, wherein the at least two wireless communication systems differ from each other by at least one of a frequency band, a modulation technique, a power level, an antenna type, and/or antenna properties.

7. The elevator system according to claim 1, wherein the at least two wireless communication systems differ from each other by a communication technology.

8. The elevator system according to claim 7, wherein the different communication technologies of the at least two wireless communication systems comprise at least two of the following communication technologies: a point-to-point microwave link, 5G, a free space optical communication technology, Bluetooth (BT), Zigbee, so that each wireless communication system is based on a different communication technology than the other wireless communication systems.

9. A method for selecting a wireless communication system for providing wireless communication connection between an elevator control unit and a car control unit arranged to an elevator car, wherein the car control unit and the elevator control unit comprise communication means to establish at least two wireless communication systems for providing wireless communication connection between the elevator control unit and the car control unit, wherein the method comprises:
obtaining, by the elevator control unit, selection data representing at least one selection parameter, wherein the at least one selection parameter comprises at least one elevator related selection parameter and/or at least one wireless communication system related selection parameter, and
selecting, by the elevator control unit, based on the obtained selection data the most appropriate wireless communication system from amongst the at least two wireless communication systems at each point of time to be used to provide the wireless communication connection between the elevator control unit and the car control unit.

10. The method according to claim 9, further comprising selecting another wireless communication system from amongst the at least two wireless communication systems to be used to provide the wireless communication connection between the elevator control unit and the car control unit, in response to detecting based on the selection data that said another wireless communication system is the most appropriate at a later point of time.

11. The method according to claim 9, wherein the at least one selection parameter is predefined or defined dynamically on a need-basis.

12. The method according to claim 9, wherein the at least one elevator related selection parameter comprises at least one of a location of the elevator car inside the elevator shaft, a speed of the elevator car, and/or a sway of a suspension device of the elevator car.

13. The method according to claim 9, wherein the at least one wireless communication system related selection parameter comprises detected interference in the wireless communication system.

14. The method according to claim 9, wherein the at least two wireless communication systems differ from each other by at least one of a frequency band, a modulation technique, a power level, an antenna type, and/or antenna properties.

15. The method according to claim 9, wherein the at least two wireless communication systems differ from each other by a communication technology.

16. The method according to claim 15, wherein the different communication technologies of the at least two wireless communication systems comprise at least two of the following communication technologies: a point-to-point microwave link, 5G, a free space optical communication technology, Bluetooth (BT), or Zigbee, so that each wireless communication system is based on a different communication technology than the other wireless communication systems.

17. A non-transitory computer readable medium storing a computer program comprising instructions which, when the program is executed by an elevator control unit, cause the elevator control unit to carry out the method according to claim 9.

18. The elevator system according to claim 2, wherein the at least one selection parameter is predefined or defined dynamically on a need-basis.

19. The elevator system according to claim 2, wherein the at least one elevator related selection parameter comprises at least one of the following: a location of the elevator car inside the elevator shaft, a speed of the elevator car, and/or a sway of a suspension device of the elevator car.

20. The elevator system according to claim 3, wherein the at least one elevator related selection parameter comprises at least one of the following: a location of the elevator car inside the elevator shaft, a speed of the elevator car, and/or a sway of a suspension device of the elevator car.
